(19) United States
(12) Patent Application Publication
(10) Pub. No.: US 2015/0248507 A1
(43) Pub. Date: Sep. 3, 2015

(54) INFORMATION SYSTEM CONSTRUCTION SUPPORT DEVICE, INFORMATION SYSTEM CONSTRUCTION SUPPORT METHOD, AND STORAGE MEDIUM

(71) Applicant: NEC Corporation, Minato-ku, Tokyo (JP)

(72) Inventor: Hiroshi Sakaki, Tokyo (JP)

(73) Assignee: NEC Corporation, Minato-ku, Tokyo (JP)

(21) Appl. No.: 14/430,602

(22) PCT Filed: Sep. 17, 2013
(86) PCT No.: PCT/JP2013/005468

§ 371 Date: Mar. 24, 2015

(30) Foreign Application Priority Data
Oct. 2, 2012 (JP) 2012-220527

(51) Int. Cl. G06F 17/50

(52) U.S. Cl. CPC G06F 17/5009

(57) ABSTRACT

A device includes a system model selection unit selecting a system model satisfying a construction requirement from a first DB when the construction requirement and the priority thereof are input, an operation information acquisition unit acquiring operation information from a second DB based on a selected system model group, a parameter computation unit computing an evaluation parameter by using a parameter of the operation information, a performance evaluation unit evaluating performance of the selected system model based on the evaluation parameter, a sizing factor determination unit determining a sizing factor of the selected system model so that the evaluated performance of the system model satisfies the construction requirement associated with the priority of a mandatory level, by comparing the evaluation result with the input construction requirement, and a construction candidate presentation unit presenting an information system constructable by using the system model after sizing factor determination as a candidate.

This application is a National Stage Entry of PCT/JP2013/005468 filed on Sep. 17, 2013, which claims priority from Japanese Patent Application 2012-220527 filed on Oct. 2, 2012, the contents of all of which are incorporated herein by reference, in their entirety.

### TECHNICAL FIELD

The present invention relates to an information system construction support device, an information system construction support method, and a storage medium.

### BACKGROUND ART

With advance of cloud computing technology, it has been possible that a user using a cloud environment constructs and manages relatively easily an information system having a size necessary for an operation by aggregating servers, storages, and the like necessary to operate the information system on a virtual data center. PTL 1 described below discloses a technique in which when a request for executing an application is issued by a user terminal in an information system under a cloud environment, an execution environment of the application is constructed under the cloud environment.

Further, PTL 2 discloses a primary cloud server in which depending on a result value of a service level provided in a primary cloud, a service level agreement is dynamically determined to select and provide a service.

### CITATION LIST

### Patent Literature

PTL 1: Japanese Laid-open Patent Publication No. 2010-218049.

PTL 2: Japanese Laid-open Patent Publication No. 2011-118451.

### SUMMARY OF INVENTION

### Technical Problem

In the technique described in PTL 1, execution environments are preset for respective combinations of resources, middleware, and the like included in operation requirements of an application. When an execution request for the application is received, an execution environment satisfying the operation requirements of the application is selected among the preset execution environments. In other words, a user operates the application under an execution environment satisfying all the operation requirements of the application requested for execution.

However, some users may not mind even when a requirement that does not reach a targeted value is present as far as a certain requirement reaches a targeted value. In such a case, an information system satisfying all requirements is not always an optimal information system for a user. On the other hand, priorities of respective requirements differ depending on a user, and therefore, it is not possible to uniformly determine the priorities of the respective requirements.

In the primary cloud server described in PTL 2, priorities of construction requirements are not taken into account.

The present invention has been achieved to solve the above problems and one object of the present invention is to provide an information system construction support device, an information system construction support method, and an information system construction support program capable of presenting an optimal information system depending on construction requirements and priorities of the construction requirements desired by a user.

### Solution to Problem

An information system construction support device of an exemplary aspect of the present invention includes: a system model selection unit that selects a system model satisfying a construction requirement among system models set in a unit of previously stored design information of a system when the construction requirement and a priority of the construction requirement for a construction planned system that is an information system to be constructed are input; an operation information acquisition unit that acquires operation information of an existing system that is an already constructed information system based on the system model selected by the system model selection unit and a similar system model similar to the system model; a parameter computation unit that computes an evaluation parameter used upon evaluating performance of the system model, by using a parameter included in the operation information acquired by the operation information acquisition unit; a performance evaluation unit that evaluates performance of the system model selected by the system model selection unit, on the basis of the evaluation parameter computed by the parameter computation unit; a server element determination unit that determines a server element that is an element for determining a size of a server included in the design information of the system model selected by the system model selection unit so that performance of the system model evaluated by the performance evaluation unit satisfies the construction requirement associated with the priority of at least a mandatory level among the construction requirements, by comparing the evaluated performance of the system model with the input construction requirement; and a construction candidate presentation unit that presents an information system constructable by using the system model having the server element determined by the server element determination unit as a candidate of the construction planned system.

An information system construction support method of an exemplary aspect of the present invention includes: selecting a system model satisfying a construction requirement among system models set in a unit of previously stored design information of a system when the construction requirement and a priority of the construction requirement for a construction planned system that is an information system to be constructed are input; acquiring operation information of an existing system that is an already constructed information system based on the selected system model and a similar system model similar to the system model; computing an evaluation parameter used upon evaluating performance of the system model, by using a parameter included in the acquired operation information; evaluating performance of the selected system model, on the basis of the computed evaluation parameter; determining a server element that is an element for determining a size of a server included in the design information of the selected system model so that the evaluated performance of the system model satisfies the construction requirement associated with the priority of at least a mandatory level among the construction requirements, by comparing the evaluated performance of the system model with the input construction requirement; and presenting an information system constructable by using the system model having the determined server element as a candidate of the construction planned system.

A computer-readable storage medium of an exemplary aspect of the present invention records an information system construction support program for causing a computer to execute: system model selection processing for selecting a system model satisfying a construction requirement among system models set in a unit of previously stored design information of a system when the construction requirement and a priority of the construction requirement for a construction planned system that is an information system to be constructed are input; operation information acquisition processing for acquiring operation information of an existing system that is an already constructed information system based on the system model selected in the system model selection processing and a similar system model similar to the system model; parameter computation processing for computing an evaluation parameter used upon evaluating performance of the system model, by using a parameter included in the operation information acquired in the operation information acquisition processing; performance evaluation processing for evaluating performance of the system model selected in the system model selection processing, on the basis of the evaluation parameter computed in the parameter computation processing; server element determination processing for determining a server element that is an element for determining a size of a server included in the design information of the system model selected in the system model selection processing so that performance of the system model evaluated in the performance evaluation processing satisfies the construction requirement associated with the priority of at least a mandatory level among the construction requirements, by comparing the evaluated performance of the system model with the input construction requirement; and construction candidate presentation processing for presenting an information system constructable by using the system model having the server element determined in the server element determination processing as a candidate of the construction planned system.

### Advantageous Effects of Invention

The present invention makes it possible to present an optimal information system depending on construction requirements and priorities of the construction requirements desired by a user.

### BRIEF DESCRIPTION OF DRAWINGS

FIG. 1 is a diagram exemplifying a configuration of an information system construction support device in an exemplary embodiment;

FIG. 2 is one example of a screen used when a user constructs an information system;

FIG. 3 is one example of a screen configuration displayed in a service level requirement input area illustrated in FIG. 2;

FIG. 4 is one example of a screen configuration displayed in a functional requirement selection area illustrated in FIG. 2;

FIG. 5 is one example of a screen configuration displayed in a system model candidate display area illustrated in FIG. 2;

FIG. 6 is one example of a screen displaying evaluation parameters;

FIG. 7 is a flowchart for illustrating a procedure upon supporting construction of an information system; and

FIG. 8 is a diagram exemplifying a configuration of an information system construction support device according to a modified example.

### DESCRIPTION OF EMBODIMENTS

With reference to the accompanying drawings, a preferred exemplary embodiment of an information system construction support device, an information system construction support method, and an information system construction support program storage medium according to the present invention will be described below. The information system construction support device according to the exemplary embodiment is a device in which performances of various information systems constructed by using virtual machines under a cloud environment are evaluated and construction of an information system matched with construction requirements and priorities thereof presented by a user is supported.

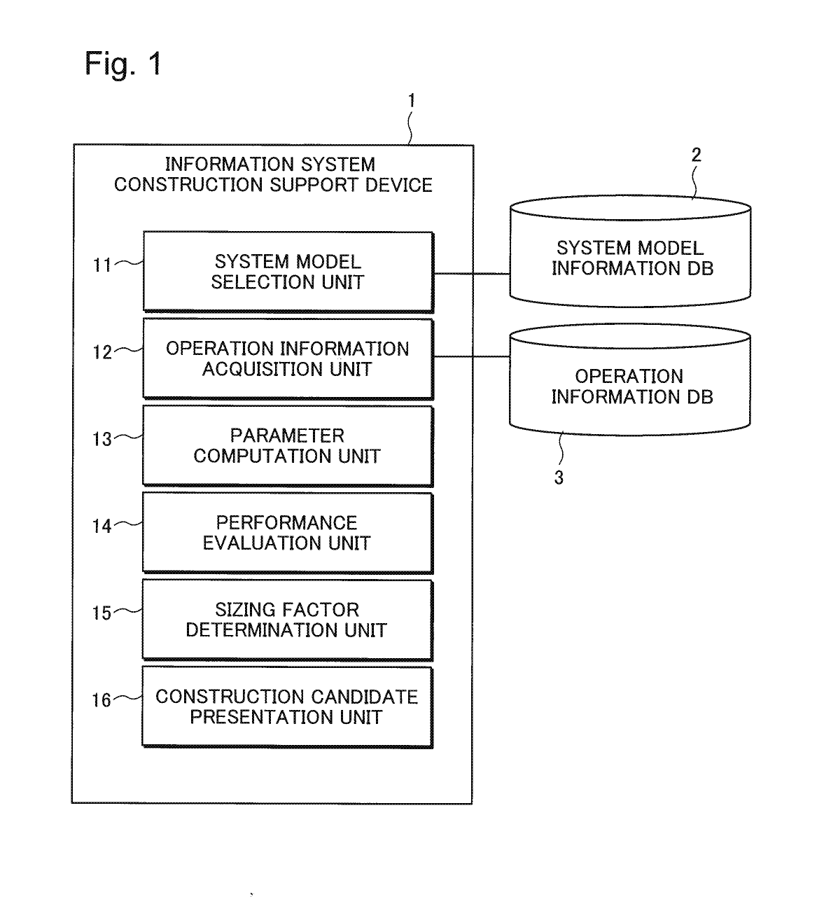

Initially, with reference to FIG. 1, a configuration of the information system construction support device according to the exemplary embodiment is described below. As illustrated in FIG. 1, an information system construction support device 1 functionally includes, for example, a system model selection unit 11, an operation information acquisition unit 12, a parameter computation unit 13, a performance evaluation unit 14, a sizing factor (server element) determination unit 15, and a construction candidate presentation unit 16.

The information system construction support device 1 physically includes, for example, a CPU (Central Processing Unit), a storage device, and an input/output interface. The storage device includes, for example, a ROM (Read Only Memory) and an HDD (Hard Disk Drive) storing a program and data processed by the CPU, a RAM (Random Access Memory) used as various types of work areas mainly for control processing, and the like. These respective elements are mutually connected via a bus. The CPU executes the program stored on the ROM and processes a message received via the input/output interface, data developed on the RAM, and the like, to realize functions of the respective units in the information system construction support device 1.

When a user inputs a construction requirement of an information system planned to be constructed from now by the user (hereinafter, referred to as a “construction planned system”), the system model selection unit 11 selects a system model satisfying the construction requirement by referring to a system model information DB 2. The system model selection unit 11 selects a plurality of system models when a plurality of system models satisfying the construction requirement exist.

As the construction requirement, for example, a functional requirement and a service level requirement are usable. The functional requirement is a condition for determining a role played by an application and includes functions such as data processing, data store, image analysis, response creation, statistical processing, inventory management, and the like. The service level requirement is a condition for determining a guarantee level of quality provided by the construction planned system and includes guarantee levels such as throughput, maximum CPU usage rate, maximum disk usage rate, network usage rate, TAT (Turn Around Time), and the like.

The system model is a model set in a design information unit for constructing an information system. The design information includes pieces of information describing, for example, a configuration of a network, a configuration of a server, a relation among components of an application, a processing flow indicating an operation of the application, and the like.

The system model information DB 2 is a database that stores system model information including design information of an already constructed information system (hereinafter, referred to as an “existing system”). The system model information DB 2 is designed so as to be able to search system model information using a construction requirement as a key. The system model information DB 2 may be included within the information system construction support device 1 or may be provided outside.

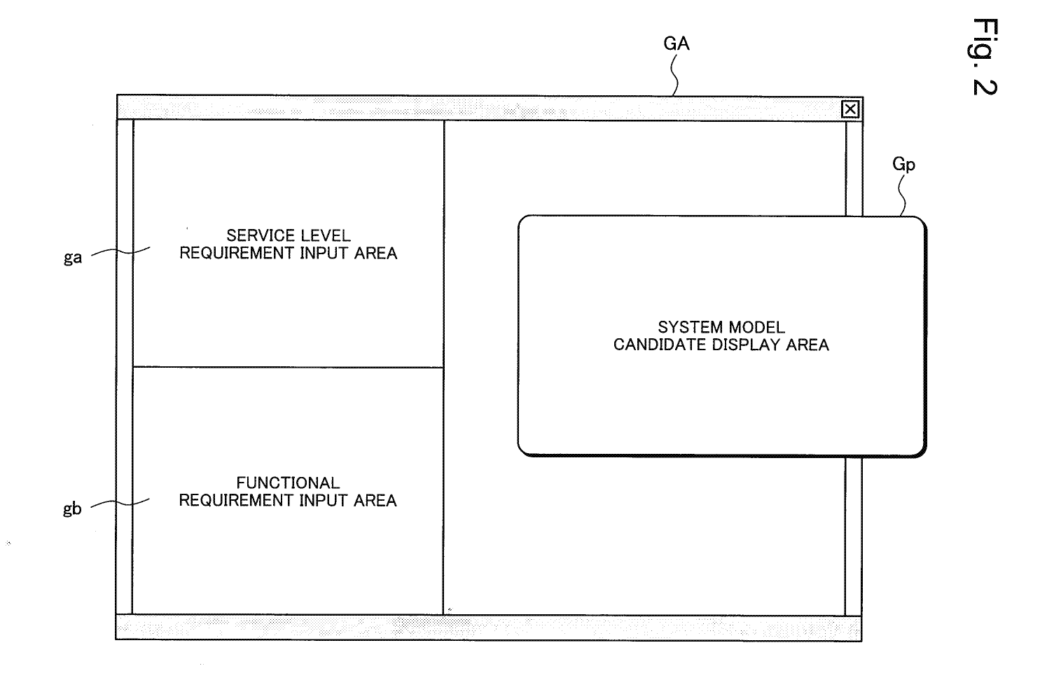

A user accesses the information system construction support device 1 by operating a user terminal (not illustrated) and determines a construction planned system using various types of screens provided by the information system construction support device 1. With reference to FIG. 2, a screen used by a user is described. FIG. 2 is one example of a screen used when a user constructs an information system. On a display screen GA, an area ga for inputting a service level requirement and an area gb for inputting a functional requirement are disposed. When a system model satisfying a construction requirement is selected, an area Gp that displays one or a plurality of selected system models as candidates is popup-displayed on the display screen GA.

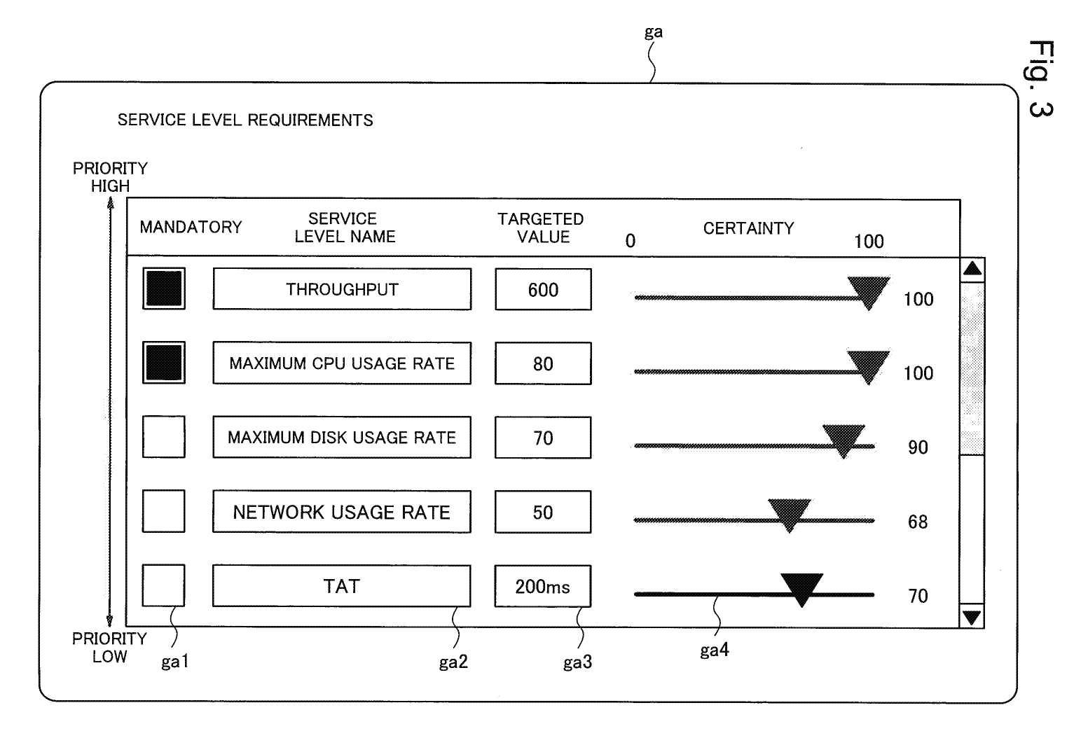

FIG. 3 illustrates one example of a screen configuration displayed in the service level requirement input area ga. As illustrated in FIG. 3, in the service level requirement input area ga, service level name items ga2 and targeted value items ga3 for inputting service level names and targeted values, respectively, set as service level requirements are displayed. As a combination of the service level name item ga2 and the targeted value item ga3 is input in an upper row of the input area ga, a priority upon evaluating performance of a system model becomes higher. In other words, a priority of the uppermost row is highest; a priority becomes lower as being in a lower row; and a priority of the lowermost row is lowest.

In the service level name items ga2 of FIG. 3, in order from the top row, “throughput,” “maximum CPU usage rate,” “maximum disk usage rate,” “network usage rate,” and “TAT” are input, and in the targeted value items ga3 associated therewith, “600,” “80,” “70,” “50,” and “200 ms” are input, respectively.

In the service level requirement input area ga, for each service level name item ga2, a mandatory item ga1 is displayed. The mandatory item ga1 is a check item for selecting whether achievement of a targeted value in a corresponding service level name item ga2 is set as a mandatory requirement or not when performance of a system model is evaluated.

In FIG. 3, checks are input in the mandatory items ga1 associated with “throughput” and “maximum CPU usage rate.” In this case, “throughput” and “maximum CPU usage rate” are mandatory requirements, and therefore, priorities of “throughput” and “maximum CPU usage rate” are highest and priority becomes lower in order of “maximum disk usage rate,” “network usage rate,” and “TAT.” Specifically, a candidate of a system model presented to a user is targeted for a system model at least having a “throughput” of at least “600” and a “maximum CPU usage rate” of at most “80” %.

In the service level requirement input area ga, a level bar ga4 is displayed for each service level name item ga2. The level bar ga4 indicates a degree of possibility for achieving a targeted value in a service level name item ga2 associated with the level bar ga4, based on a simulation result of a system model selected by a user as an evaluation target.

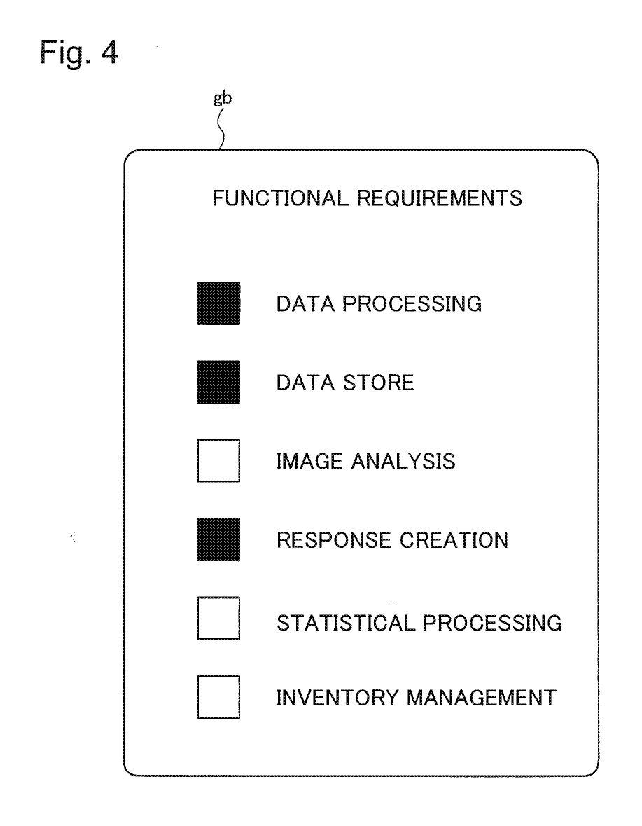

FIG. 4 illustrates one example of a screen configuration displayed in the functional requirement selection area gb. As illustrated in FIG. 4, in the functional requirement selection area gb, various types of items for selectively inputting data processing, data store, image analysis, response creation, statistical processing, and inventory management as functional requirements are displayed. A user inputs a desired functional requirement for a construction planned system through the functional requirement selection area gb.

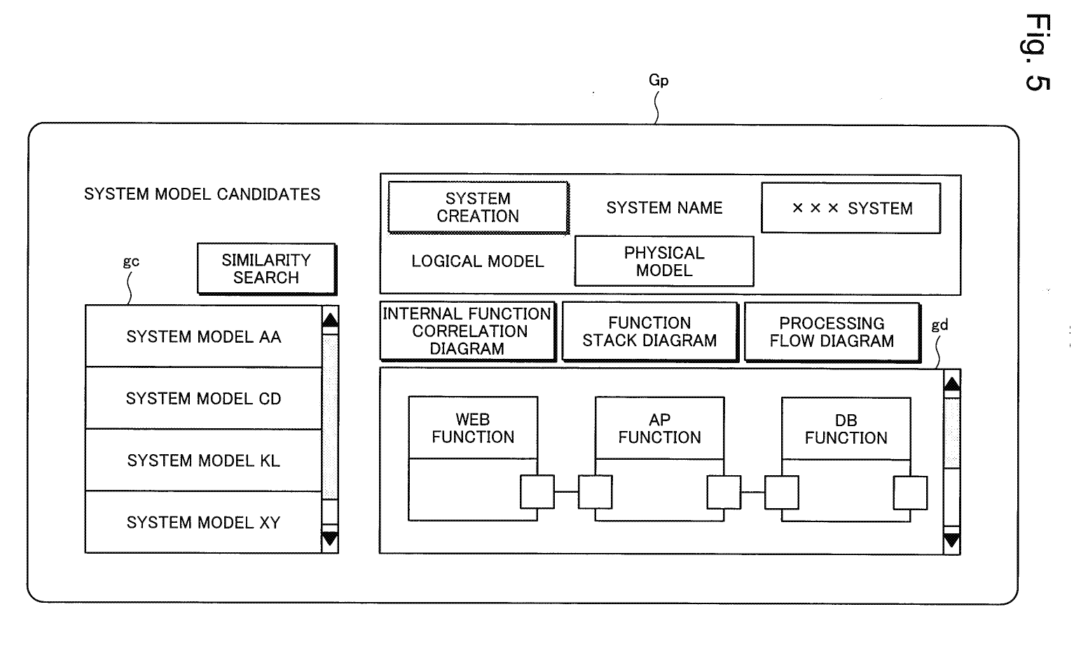

FIG. 5 illustrates one example of a screen configuration displayed in the system model candidate display area Gp. As illustrated in FIG. 5, the system model candidate display area Gp includes an area gc for selecting a system model to be employed for performance evaluation and an area gd for displaying a model diagram of the system model selected in the selection area gc.

In the selection area gc, one or a plurality of system models selected by the system model selection unit 11 are displayed. The model diagram displayed in the display area gd includes, for example, an internal function correlation diagram, a function stack diagram, a processing flow diagram, and the like. A user causes performance evaluation of a construction planned system and construction of an information system to be executed, through the system model candidate display area Gp. Specifically, a user selects, for example, one system model in the selection area gc and causes performance evaluation of a construction planned system to be executed by clicking a similarity search button. A user accepting the evaluation result causes construction of an information system to be executed by clicking a system creation button.

The operation information acquisition unit 12 illustrated in FIG. 1 acquires operation information of an existing system constructed in the past by employing a system model selected by the system model selection unit 11, from an operation information DB 3. When a plurality of system models selected by the system model selection unit 11 exist, the operation information acquisition unit 12 acquires operation information of an existing system employing a system model selected by a user in the selection area gc, from the operation information DB 3.

The operation information acquisition unit 12 further acquires operation information of an existing system constructed in the past by employing a system model similar to the system model selected by the system model selection unit 11, from the operation information DB 3. In the present exemplary embodiment, for convenience of description, a set of the system model selected by the system model selection unit 11 and a system model similar to the system model is referred to as a “selected system model group.”

As the system model similar to the selected system model, for example, a system model having design information different from design information of the selected system model only in a sizing factor of a server, is employable.

The sizing factor of a server is an element (server element) for determining a size of the server and includes, for example, the number of servers, the number of cores of a CPU mounted in the server, and the like.

The operation information is information managed by an operator operating an information system and includes, for example, a load of a CPU, a processing number of requests, a failure history of a hard disk, and the like.

The operation information DB 3 is a database that stores operation information of an existing system. The operation information DB 3 is designed so as to be able to search operation information using a system model as a key. The operation information DB 3 may be included within the information system construction support device 1 or may be provided outside.

The parameter computation unit 13 computes evaluation parameters used upon evaluating non-functional requirements such as performance and reliability of an information system, expandability, security, and mission critical property (hereinafter, referred to as “MC (Mission Critical) property”), by using parameters included in operation information acquired by the operation information acquisition unit 12. Indicators of the non-functional requirements increase as quality indicators, such as reliability, availability, and maintainability, and performance indicators such as performance increase.

As the parameters, for example, an arrival rate of requests, an average transmission size of application messages, a Web load represented by an average CPU time, a Web read load represented by a disk read time, a Web write load represented by a disk write time, an average size on SQL execution, an application load represented by an average CPU time, an application write load represented by a disk write time, and the like are usable.

The evaluation parameter is provided in accordance with each parameter included in operation information of a selected system model group acquired by the operation information acquisition unit 12. As a value of the evaluation parameter, an average value of parameter values of the selected system model group is set.

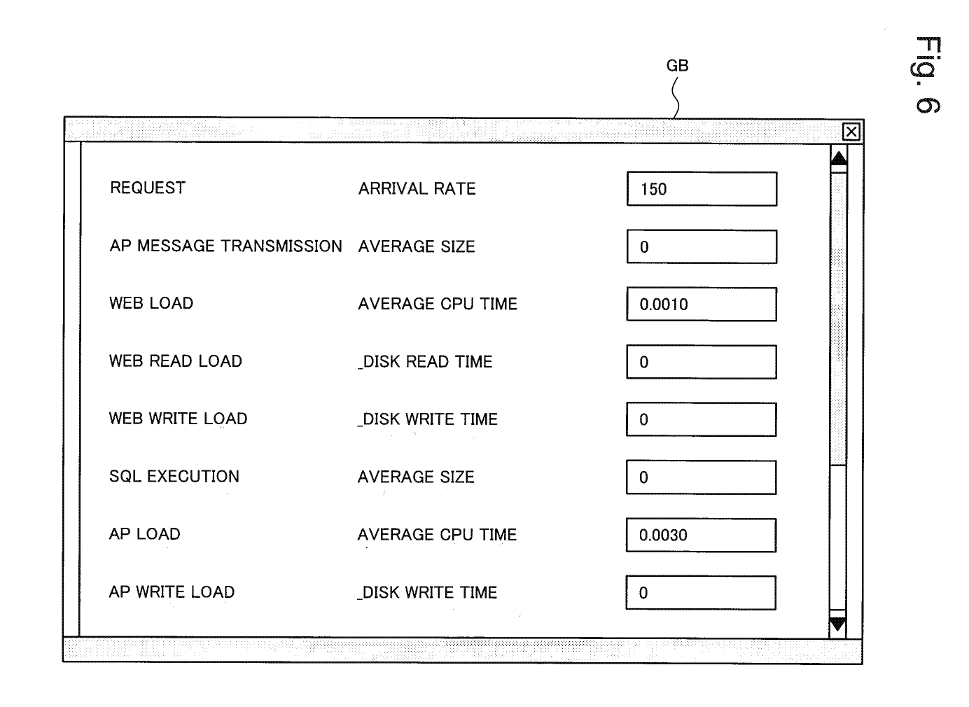

FIG. 6 illustrates one example of a display screen of evaluation parameters. As illustrated in FIG. 6, in an evaluation parameter display screen GB, item names of evaluation parameters and values of the evaluation parameters are displayed in a list format.

The performance evaluation unit 14 illustrated in FIG. 1 evaluates performance of a system model selected by the system model selection unit 11, on the basis of evaluation parameters computed by the parameter computation unit 13.

The sizing factor determination unit 15 compares the result of evaluation performed by the performance evaluation unit 14 with service level requirements input by a user in consideration of priorities of the service level requirements, and determines a sizing factor of the system model selected by the system model selection unit 11. In other words, the sizing factor determination unit 15 determines a sizing factor of the selected system model so that the system model selected by the system model selection unit 11 satisfies the service level requirements as much as possible in consideration of the priorities of the requirements input by the user.

Specifically, the sizing factor determination unit 15 determines a sizing factor of the system model selected by the system model selection unit 11 so that performance of the selected system model satisfies at least service level requirements in which checks are input in the mandatory items ga1 of FIG. 3. In this case, a service level requirement in which no check is input in the mandatory item ga1 of FIG. 3 may not be necessarily satisfied, but the sizing factor is determined by setting weighting so that the extent of being not satisfied decreases as a priority associated with the service level requirement is higher.

The construction candidate presentation unit 16 presents an information system constructable by using a system model after sizing factor determination by the sizing factor determination unit 15 to a user terminal as a candidate of a construction planned system.

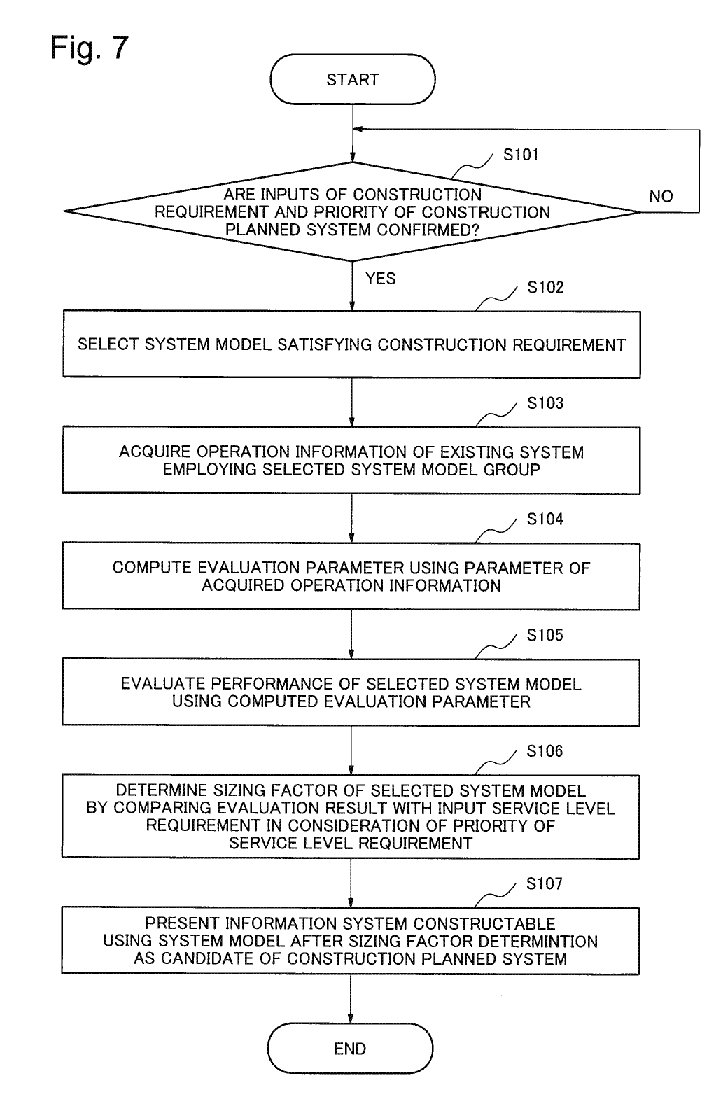

Next, with reference to FIG. 7, an operation of the information system construction support device 1 will be described. FIG. 7 is a flowchart for illustrating a procedure used upon supporting construction of an information system.

Initially, the system model selection unit 11 determines whether or not respective inputs of functional requirements, service level requirements, and priorities of the service level requirements of a construction planned system are confirmed by a user (step S101). When this determination is NO (step S101; NO), the processing waits until YES is obtained.

On the other hand, in the determination of step S101, when respective inputs of the functional requirements, the service level requirements, and the priorities thereof are determined to be confirmed (step S101; YES), the system model selection unit 11 selects a system model satisfying the functional requirements and the service level requirements by referring to the system model information DB 2 (step S102). When a plurality of selected system models exist, the user is allowed to select any one of the system models to be narrowed down to one system model to be selected in step S102.

The operation information acquisition unit 12 acquires operation information of an existing system employing the system model selected in step S102 above and a system model similar to the system model respectively from the operation information DB 3 (step S103).

The parameter computation unit 13 computes evaluation parameters used upon evaluating non-functional requirements of an information system, by using parameters included in the operation information acquired in step S103 above (step S104).

The performance evaluation unit 14 evaluates performance of the system model selected in step S102 above, on the basis of the evaluation parameters computed in step S104 above (step S105).

The sizing factor determination unit 15 compares the evaluation result obtained in step S105 above with the service level requirements input in step S101 above in consideration of the priorities of the service level requirements input in step S101 above, and determines a sizing factor of the system model selected in step S102 above (step S106).

The construction candidate presentation unit 16 presents an information system constructable by using the system model after sizing factor determination in step S106 above to the user as a candidate of a construction planned system (step S107).

As described above, the information system construction support device 1 according to the exemplary embodiment makes it possible that the system model selection unit 11 selects a system model satisfying functional requirements and service level requirements input by a user; the operation information acquisition unit 12 acquires operation information of an existing system associated with a selected system model group; the parameter computation unit 13 computes evaluation parameters by using parameters included in the acquired operation information above; the performance evaluation unit 14 evaluates performance of the selected system model above based on the evaluation parameters; the sizing factor determination unit 15 compares the evaluated performance above of the system model with the input service level requirements above in consideration of priorities of the input service level requirements above and determines a sizing factor of a server included in design information of the selected system model above; and the construction candidate presentation unit 16 presents an information system constructable by using the system model after sizing factor determination as a candidate of a construction planned system.

This makes it possible that a system model satisfying construction requirements input by a user is selected as a candidate of a construction planned system; based on evaluation parameters computed based on operation information of an existing system associated with a selected system model group, non-functional requirements of the selected system model are evaluated; the evaluation result and service level requirements input by the user are compared in consideration of priorities of the service level requirements input by the user to determine a sizing factor matched with the requirements input by the user; and an information system constructable by using the system model after sizing factor determination is presented to the user.

Therefore, the information system construction support device 1 according to the exemplary embodiment makes it possible to present an optimal information system depending on functional requirements, service level requirements, and priorities of the service level requirements desired by a user.

The exemplary embodiment described above is only illustrative and does not exclude various modifications and applications of the technique which are not expressed in the exemplary embodiment. In other words, the present invention can be carried out by being modified to various embodiments without departing from the gist of the present invention.

For example, in the exemplary embodiment described above, the sizing factor determination unit 15 determines a sizing factor in consideration of priorities of service level requirements, but may determine the sizing factor in consideration of priorities of functional requirements in addition to the priorities of the service level requirements. In this case, in the same manner as the service level requirement input area ga illustrated in FIG. 3, the functional requirement selection area gb illustrated in FIG. 4 may be configured to set the priorities of the respective functional requirements.

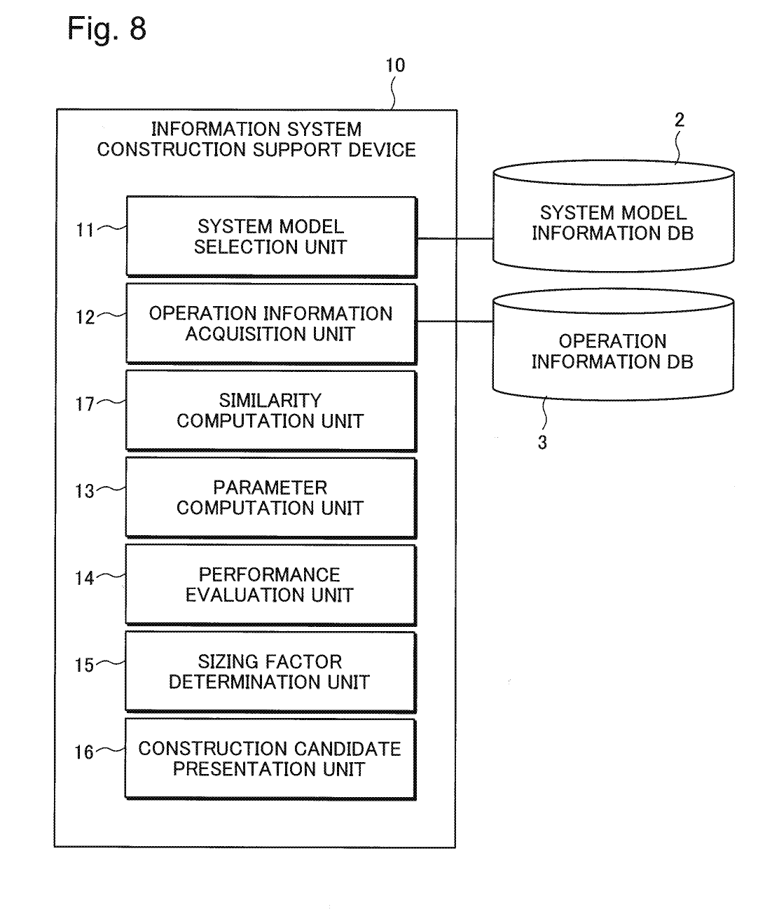

Further, to the information system construction support device according to the exemplary embodiment described above, a similarity computation function described below may be added as an option. With reference to FIG. 8, a configuration of an information system construction support device according to the present modified example is described below.

An information system construction support device 10 according to the modified example is different from the information system construction support device 1 according to the exemplary embodiment described above in a respect that a similarity computation unit 17 is added and a part of the function of the sizing factor determination unit 15 is modified. The configurations other than the above are the same as the respective configurations of the information system construction support device 1 according to the exemplary embodiment. Therefore, the same reference sign is assigned to each constituent element and description thereof is omitted. In the following, differences from the exemplary embodiment will be mainly described.

The similarity computation unit 17 compares parameters included in the operation information acquired by the operation information acquisition unit 12 with input construction requirements and computes similarity to the input construction requirement with respect to each piece of operation information.

The sizing factor determination unit 15 determines a sizing factor by using robust optimization to be described later, with a reciprocal of the similarity computed by the similarity computation unit 17 as a factor of uncertainty, upon determining the sizing factor.

The uncertainty and the robust optimization are described below. In general, a problem in the world has various types of uncertainty. When, for example, a problem of building a production plan in the future is modeled, data in the past is often used upon setting predicted values for future demand and cost, but these values include prediction errors, resulting in that these prediction errors become a factor of uncertainty. As a method for dealing with such uncertainty, well-known robust optimization is available. This robust optimization is a method in which a range of uncertainty is previously set and a case that the worst case happens in the range is assumed to perform optimization. Therefore, a system optimized by using robust optimization can achieve the object even when the predicable worst case happens.

In the present modified example, a reciprocal of the similarity computed by the similarity computation unit 17 is used as a factor of uncertainty, and a sizing factor is determined so as to satisfy construction requirements even when the reciprocal of the similarity reaches the predicted worst value.

In this manner, the information system construction support device 10 according to the modified example makes it possible to present an information system capable of achieving the object to a user even when the predicable worst case happens, in addition to the effect produced by the information system construction support device 1 according to the exemplary embodiment described above.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

A part or whole of the exemplary embodiment described above can be described as the following supplementary notes but the present invention is not limited to the following.

(Supplementary Note 1)

An information system construction support device including: a system model selection unit that selects a system model satisfying a construction requirement among system models set in a unit of previously stored design information of a system when the construction requirement and a priority of the construction requirement for a construction planned system that is an information system to be constructed are input; an operation information acquisition unit that acquires operation information of an existing system that is an already constructed information system based on the system model selected by the system model selection unit and a similar system model similar to the system model; a parameter computation unit that computes an evaluation parameter used upon evaluating performance of the system model, by using a parameter included in the operation information acquired by the operation information acquisition unit; a performance evaluation unit that evaluates performance of the system model selected by the system model selection unit, on the basis of the evaluation parameter computed by the parameter computation unit; a server element determination unit that determines a server element that is an element for determining a size of a server included in the design information of the system model selected by the system model selection unit so that performance of the system model evaluated by the performance evaluation unit satisfies the construction requirement associated with the priority of at least a mandatory level among the construction requirements, by comparing the evaluated performance of the system model with the input construction requirement; and a construction candidate presentation unit that presents an information system constructable by using the system model having the server element determined by the server element determination unit as a candidate of the construction planned system.

(Supplementary Note 2)

The information system construction support device according to Supplementary Note 1, further including similarity computation unit that computes similarity to the input construction requirement with respect to each piece of the operation information by comparing a parameter included in the operation information acquired by the operation information acquisition unit with the input construction requirement, wherein the server element determination unit uses a reciprocal of the similarity computed by the similarity computation unit as a factor of uncertainty and determines the server element by using robust optimization.

(Supplementary Note 3)

The information system construction support device according to Supplementary Note 1 or 2, wherein the construction requirement is a functional requirement for determining a role played by an application and a service level requirement for determining a guarantee level of quality provided by the construction planned system, and the server element determination unit determines the server element so that performance of the system model evaluated by the performance evaluation unit satisfies the service level requirement associated with the priority of at least a mandatory level among the service level requirements, by comparing the evaluated performance of the system model with the input service level requirement.

(Supplementary Note 4)

The information system construction support device according to any one of Supplementary Notes 1 to 3, wherein the similar system model is the system model with another piece of the design information different from the design information of the system model selected by the system model selection unit in only the server element.

(Supplementary Note 5)

The information system construction support device according to any one of Supplementary Notes 1 to 4, wherein performance of the system model is a non-functional requirement.

(Supplementary Note 6)

An information system construction support method including: a system model selection step of selecting a system model satisfying a construction requirement among system models set in a unit of previously stored design information of a system when the construction requirement and a priority of the construction requirement for a construction planned system that is an information system to be constructed are input; an operation information acquisition step of acquiring operation information of an existing system that is an already constructed information system based on the system model selected in the system model selection step and a similar system model similar to the system model; a parameter computation step of computing an evaluation parameter used upon evaluating performance of the system model, by using a parameter included in the operation information acquired in the operation information acquisition step; a performance evaluation step of evaluating performance of the system model selected in the system model selection step, on the basis of the evaluation parameter computed in the parameter computation step; a server element determination step of determining a server element that is an element for determining a size of a server included in the design information of the system model selected in the system model selection step so that performance of the system model evaluated in the performance evaluation step satisfies the construction requirement associated with the priority of at least a mandatory level among the construction requirements, by comparing the evaluated performance of the system model with the input construction requirement; and a construction candidate presentation step of presenting an information system constructable by using the system model having the server element determined in the server element determination step as a candidate of the construction planned system.

(Supplementary Note 7)

The information system construction support method according to Supplementary Note 6, further including a similarity computation step of computing similarity to the input construction requirement with respect to each piece of the operation information by comparing a parameter included in the operation information acquired in the operation information acquisition step with the input construction requirement, wherein the server element determination step uses a reciprocal of the similarity computed in the similarity computation step as a factor of uncertainty and determines the server element by using robust optimization.

(Supplementary Note 8)

The information system construction support method according to Supplementary Note 6 or 7, wherein the construction requirement is a functional requirement for determining a role played by an application and a service level requirement for determining a guarantee level of quality provided by the construction planned system, and the server element determination step determines the server element so that performance of the system model evaluated in the performance evaluation step satisfies the service level requirement associated with the priority of at least a mandatory level among the service level requirements, by comparing the evaluated performance of the system model with the input service level requirement.

(Supplementary Note 9)

The information system construction support method according to any one of Supplementary Notes 6 to 8, wherein the similar system model is the system model with another piece of the design information different from the design information of the system model selected in the system model selection step in only the server element.

(Supplementary Note 10)

The information system construction support method according to any one of Supplementary Notes 6 to 9, wherein performance of the system model is a non-functional requirement.

(Supplementary Note 11)

A computer-readable storage medium that records an information system construction support program for causing a computer to execute: system model selection processing for selecting a system model satisfying a construction requirement among system models set in a unit of previously stored design information of a system when the construction requirement and a priority of the construction requirement for a construction planned system that is an information system to be constructed are input; operation information acquisition processing for acquiring operation information of an existing system that is an already constructed information system based on the system model selected in the system model selection processing and a similar system model similar to the system model; parameter computation processing for computing an evaluation parameter used upon evaluating performance of the system model, by using a parameter included in the operation information acquired in the operation information acquisition processing; performance evaluation processing for evaluating performance of the system model selected in the system model selection processing, on the basis of the evaluation parameter computed in the parameter computation processing; server element determination processing for determining a server element that is an element for determining a size of a server included in the design information of the system model selected in the system model selection processing so that performance of the system model evaluated in the performance evaluation processing satisfies the construction requirement associated with the priority of at least a mandatory level among the construction requirements, by comparing the evaluated performance of the system model with the input construction requirement; and construction candidate presentation processing for presenting an information system constructable by using the system model having the server element determined in the server element determination processing as a candidate of the construction planned system.

(Supplementary Note 12)

The computer-readable storage medium according to Supplementary Note 11, wherein the information system construction support program causes a computer to further execute similarity computation processing for computing similarity to the input construction requirement with respect to each piece of the operation information by comparing a parameter included in the operation information acquired in the operation information acquisition processing with the input construction requirement, and the server element determination processing uses a reciprocal of the similarity computed in the similarity computation processing as a factor of uncertainty and determines the server element by using robust optimization.

(Supplementary Note 13)

The computer-readable storage medium according to Supplementary Note 11 or 12, wherein the construction requirement is a functional requirement for determining a role played by an application and a service level requirement for determining a guarantee level of quality provided by the construction planned system, and the server element determination processing determines the server element so that performance of the system model evaluated in the performance evaluation processing satisfies the service level requirement associated with the priority of at least a mandatory level among the service level requirements, by comparing the evaluated performance of the system model with the input service level requirement.

(Supplementary Note 14)

The computer-readable storage medium according to any one of Supplementary Notes 11 to 13, wherein the similar system model is the system model with another piece of the design information different from the design information of the system model selected in the system model selection processing in only the server element.

(Supplementary Note 15)

The computer-readable storage medium according to any one of Supplementary Notes 11 to 14, wherein performance of the system model is a non-functional requirement.

This application is based upon and claims the benefit of priority from Japanese patent application No. 2012-220527, filed on Oct. 2, 2012, the disclosure of which is incorporated herein in its entirety by reference.

### REFERENCE SIGNS LIST

1, 10 Information system construction support device
2 System model information DB
3 Operation information DB
11 System model selection unit
12 Operation information acquisition unit
13 Parameter computation unit
14 Performance evaluation unit
15 Sizing factor determination unit
16 Construction candidate presentation unit
17 Similarity computation unit

What is claimed is:

1. An information system construction support device comprising:
a system model selection unit that selects a system model satisfying a construction requirement among system models set in a unit of previously stored design information of a system when the construction requirement and a priority of the construction requirement for a construction planned system that is an information system to be constructed are input;
an operation information acquisition unit that acquires operation information of an existing system that is an already constructed information system based on the system model selected by the system model selection unit and a similar system model similar to the system model;
a parameter computation unit that computes an evaluation parameter used upon evaluating performance of the system model, by using a parameter included in the operation information acquired by the operation information acquisition unit;
a performance evaluation unit that evaluates performance of the system model selected by the system model selection unit, on the basis of the evaluation parameter computed by the parameter computation unit;
a server element determination unit that determines a server element that is an element for determining a size of a server included in the design information of the system model selected by the system model selection unit so that performance of the system model evaluated by the performance evaluation unit satisfies the construction requirement associated with the priority of at least a mandatory level among the construction requirements, by comparing the evaluated performance of the system model with the input construction requirement; and
a construction candidate presentation unit that presents an information system constructable by using the system model having the server element determined by the server element determination unit as a candidate of the construction planned system.

2. The information system construction support device according to claim 1, further comprising a similarity computation unit that computes similarity to the input construction requirement with respect to each piece of the operation information by comparing a parameter included in the operation information acquired by the operation information acquisition unit with the input construction requirement, wherein
the server element determination unit uses a reciprocal of the similarity computed by the similarity computation unit as a factor of uncertainty and determines the server element by using robust optimization.

3. The information system construction support device according to claim 1 wherein
the construction requirement is a functional requirement for determining a role played by an application and a service level requirement for determining a guarantee level of quality provided by the construction planned system, and the server element determination unit determines the server element so that performance of the system model evaluated by the performance evaluation unit satisfies the service level requirement associated with the priority of at least a mandatory level among the service level requirements, by comparing the evaluated performance of the system model with the input service level requirement.

4. The information system construction support device according to claim 1 wherein
the similar system model is the system model with another piece of the design information different from the design information of the system model selected by the system model selection unit in only the server element.

5. The information system construction support device according to claim 1, wherein
performance of the system model is a non-functional requirement.

6. An information system construction support method comprising:
selecting a system model satisfying a construction requirement among system models set in a unit of previously stored design information of a system when the construction requirement and a priority of the construction requirement for a construction planned system that is an information system to be constructed are input;
acquiring operation information of an existing system that is an already constructed information system based on the selected system model and a similar system model similar to the system model;
computing an evaluation parameter used upon evaluating performance of the system model, by using a parameter included in the acquired operation information;
evaluating performance of the selected system model, on the basis of the computed evaluation parameter;
determining a server element that is an element for determining a size of a server included in the design information of the selected system model so that the evaluated performance of the system model satisfies the construction requirement associated with the priority of at least a mandatory level among the construction requirements, by comparing the evaluated performance of the system model with the input construction requirement; and
presenting an information system constructable by using the system model having the determined server element as a candidate of the construction planned system.

7. The information system construction support method according to claim 6, further comprising:
computing similarity to the input construction requirement with respect to each piece of the operation information by comparing a parameter included in the acquired operation information with the input construction requirement; and
using a reciprocal of the computed similarity as a factor of uncertainty and determining the server element by robust optimization in determination of the server element.

8. The information system construction support method according to claim 6, wherein
the construction requirement is a functional requirement for determining a role played by an application and a service level requirement for determining a guarantee level of quality provided by the construction planned system, and the server element is determined so that the evaluated performance of the system model satisfies the service level requirement associated with the priority of at least a mandatory level among the service level requirements, by comparing the evaluated performance of the system model with the input service level requirement, in determination of the server element.

9. The information system construction support method according to claim 6, wherein
the similar system model is the system model with another piece of the design information different from the design information of the selected system model in only the server element.

10. The information system construction support method according to claim 6, wherein
performance of the system model is a non-functional requirement.

11. A computer-readable storage medium that records an information system construction support program for causing a computer to execute:
system model selection processing for selecting a system model satisfying a construction requirement among system models set in a unit of previously stored design information of a system when the construction requirement and a priority of the construction requirement for a construction planned system that is an information system to be constructed are input;
operation information acquisition processing for acquiring operation information of an existing system that is an already constructed information system based on the system model selected in the system model selection processing and a similar system model similar to the system model;
parameter computation processing for computing an evaluation parameter used upon evaluating performance of the system model, by using a parameter included in the operation information acquired in the operation information acquisition processing;
performance evaluation processing for evaluating performance of the system model selected in the system model selection processing, on the basis of the evaluation parameter computed in the parameter computation processing;
server element determination processing for determining a server element that is an element for determining a size of a server included in the design information of the system model selected in the system model selection processing so that performance of the system model evaluated in the performance evaluation processing satisfies the construction requirement associated with the priority of at least a mandatory level among the construction requirements, by comparing the evaluated performance of the system model with the input construction requirement; and
construction candidate presentation processing for presenting an information system constructable by using the system model having the server element determined in the server element determination processing as a candidate of the construction planned system.

12. The computer-readable storage medium according to claim 11, wherein
the information system construction support program causes a computer to further execute similarity computation processing for computing similarity to the input construction requirement with respect to each piece of the operation information by comparing a parameter included in the operation information acquired in the operation information acquisition processing with the input construction requirement, and
the server element determination processing uses a reciprocal of the similarity computed in the similarity computation processing as a factor of uncertainty and determines the server element by using robust optimization.

13. The computer-readable storage medium according to claim 11 wherein
the construction requirement is a functional requirement for determining a role played by an application and a service level requirement for determining a guarantee level of quality provided by the construction planned system, and the server element determination processing determines the server element so that performance of the system model evaluated in the performance evaluation processing satisfies the service level requirement associated with the priority of at least a mandatory level among the service level requirements, by comparing the evaluated performance of the system model with the input service level requirement.

14. The computer-readable storage medium according to claim 11, wherein
the similar system model is the system model with another piece of the design information different from the design information of the system model selected in the system model selection processing in only the server element.

15. The computer-readable storage medium according to claim 11 wherein
performance of the system model is a non-functional requirement.
